(19) United States
(12) Patent Application Publication
(10) Pub. No.: US 2010/0155340 A1
(43) Pub. Date: Jun. 24, 2010

(54) RAINWATER CAPTURE AND DISPENSATION METHOD

(76) Inventor: Kellie L. Fuller, Aztec, NM (US)

Correspondence Address: RODEY, DICKASON, SLOAN, AKIN & ROBB, PA, P.O. BOX 1888, ALBUQUERQUE, NM, 87103, US

(21) Appl. No.: 12/713,932

(22) Filed: Feb. 26, 2010

Related U.S. Application Data
(62) Division of application No. 11/982,816, filed on Nov. 2, 2007.

(51) Int. Cl. E03F 1/00; C02F 1/00; B01D 21/00; E02B 13/00

(52) U.S. Cl. 210/747; 210/776

(57) ABSTRACT

A rainwater storage and dispensation system including a barrel with an inlet, a drainage outlet located on a bottom wall of the barrel, and a hose assembly connected to the drainage outlet that allows collected rainwater to be dispensed. Additionally, an overflow outlet is located on the sidewall of the barrel near the top of the barrel, and the overflow outlet is sized such that its diameter is equal to or greater than the inlet to prevent the barrel from overflowing. The overflow outlet is sized sufficiently large to allow debris floating in or on top of the rainwater to be expelled through the overflow port.

### CROSS-REFERENCE AND RELATIONSHIP TO OTHER APPLICATIONS

This application is a divisional of, and claims priority to and the benefit of, U.S. patent application Ser. No. 11/982,816, entitled “RAINWATER CAPTURE AND DISPENSATION METHOD AND APPARATUS,” filed on Nov. 2, 2007, the specification of which is incorporated herein by reference.

### FIELD OF THE INVENTION

The present invention relates to rainwater capture, collection, storage, and dispensation systems, and more particularly to a new rainwater capture and dispensation method and apparatus

### BACKGROUND OF THE INVENTION

Many households desire to store rainwater for later use. This is particularly true in areas subject to drought or where underground aquifers are being depleted and the need for rainwater capture and storage systems will only increase with global warming. Even in areas with significant rain, the storage of rainwater during periods of heavy rainfall is advantageous as it can be released when the ground is better able to absorb it rather than overtaxing a municipal storm drain infrastructure.

Many prior art devices that collect rainwater present problems addressed by the present invention including obstruction of water flow from clogged filters, backup of rainwater into the gutter due to an undersized overflow port, or drainage of water from the overflow port occurring next to the house damaging its foundation. Additionally, many combine plastic tanks with metal fittings which tend to leak over time. Finally, the spigot location is often not located at the lowest point of the tank which leads to sediment buildup and does not maximize outlet water pressure.

For example, U.S. Pat. No. 6,941,702 to Abrams discloses a rainwater collection and dispensation system comprising a tank located beneath a gutter, which is mounted along the roof of a building. An overflow pipe member is directed downwardly into the ground. Since the overflow pipe member drains directly downward into the ground next to the building, damage to the building's foundation is possible.

U.S. Pat. No. 7,025,879 to Ticknor discloses a rainwater collection apparatus comprising a reservoir located adjacent to a building underneath the building's downspout or eave. One or more overflow ports provide egress from the reservoir. Since the overflow port drains directly downward into the ground next to the building, damage to the building's foundation is possible. Ticknor further discloses a screen at the intake to catch large debris and requires the screen to be manually cleared of debris periodically in order to prevent the screen from clogging up, which prevents rainwater from entering the reservoir. The rainwater collection apparatus also discloses a submersible pump, which will naturally require periodic maintenance and repair. The rainwater collection apparatus also discloses outlets constructed of a combination of plastic and metal, which, since these materials have different expansion and contraction rates, subject the apparatus to a high probability of leaks.

U.S. Pat. No. 6,966,333 to Kuehneman discloses a rainwater collection device comprising a housing for collecting rainwater whose supply line is removably coupled to the gutter of a building. An overflow pipe extends downward into the ground. Since the overflow pipe extends downward into the ground next to the building, damage to the building's foundation is possible. Also disclosed is a drainage pipe that is located on a sidewall rather than on the underside, or at the lowest point, of the housing. A method for dealing with sediment that collects in the bottom of the housing is not disclosed, thus the drainage pipe is also susceptible to clogging. Further, Kuehneman does not disclose a method of dealing with debris from the roof and gutter runoff, thus the system is susceptible to clogging at the supply line as well as clogging at the overflow pipe, thereby leading to a backup into the gutter.

U.S. Pat. No. 6,182,680 to Hart, discloses a rainwater vessel comprising an ingress tube connected via a flexible tube to a downpipe forming part of a house rain water collection system usually involving spouting. An overflow pipe is also disclosed. Since the overflow pipe is not directed away from the house, damage to the house's foundation is possible. Also disclosed is an outlet tap that is located on a sidewall of the vessel's main body, rather than on the underside, or at the lowest point, of the vessel's main body. A method for dealing with sediment that collects in the bottom of the vessel's main body is not disclosed, thus the outlet tap is also susceptible to clogging.

Consequently, there is a need for a domestic rainwater capture and dispensation method and apparatus that effectively deals with excess rainwater as well as debris and sediment from rooftop runoff. In these respects, the rainwater capture and dispensation method and apparatus of the present invention substantially departs from the designs of the prior art.

### SUMMARY OF THE INVENTION

The present invention comprises a rainwater storage and dispensation system. It includes a barrel with an inlet through which rainwater is delivered into the barrel, and a drainage outlet located on a bottom wall of the barrel. A hose assembly is connected to the drainage outlet that allows collected rainwater to be dispensed and used for a variety of purposes. Additionally, an overflow outlet is located on the sidewall of the barrel near the top of the barrel, and the overflow outlet is sized such that its diameter is equal to or greater than the inlet to prevent the barrel from overflowing by ensuring that the rate of water exiting through the overflow port can match or exceed the rate of water entering through the inlet. Additionally, the overflow outlet is sized sufficiently large to allow debris floating in or on top of the rainwater to be expelled through the overflow outlet during overflow periods. Finally, a flexible overflow discharge line sized equal to or greater than the overflow outlet is connected to the overflow outlet to direct the overflowing water to a location desired by a user.

### DESCRIPTION OF ATTACHED FIGURES AND PICTURES

FIG. 1 is a perspective view of the present invention.

FIG. 2 is a perspective partial cutaway view of the present invention.

FIG. 3 is a bottom perspective view of the drainage outlet and hose assembly of the present invention.

### DESCRIPTION OF PREFERRED EMBODIMENT OF THE INVENTION

With reference to the figures, the present invention of a new rainwater capture and dispensation system, designated by reference number 10, will now be described.

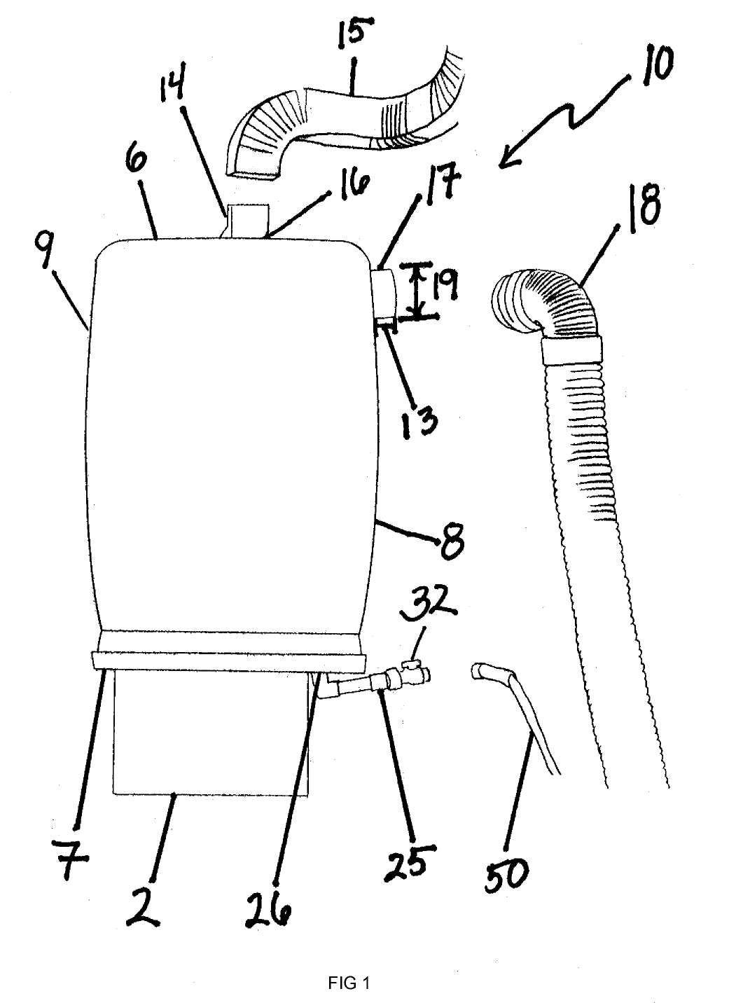

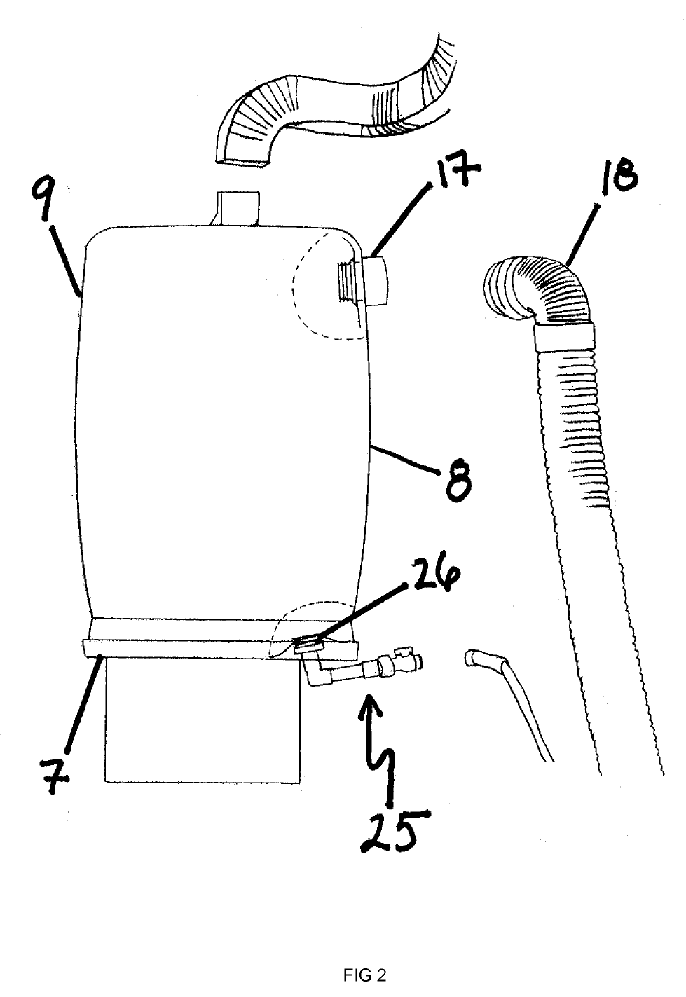

With reference to FIG. 1, the rainwater capture and dispensation system 10 generally comprises a supply line 15 that is detachably connected to a barrel inlet 16 via a barrel inlet coupling 14. A plastic barrel 9 has a side wall 8, a top wall 6 and a bottom wall 7. A base 2 is used to raise barrel 9 to a sufficient height to allow a hose assembly 25 to detachably connect to a drainage outlet 26 (depicted in FIG. 2), which is located at or near the lowest point of bottom wall 7 of barrel 9. An overflow outlet 17 is conventionally disposed through the side wall 8 of barrel 9 to route rainwater and floating debris out of barrel 9 when barrel 9 is almost full. To prevent rainwater and debris from backing up into supply line 15, overflow outlet 17 has a diameter 19 that is equal to or larger than the diameter of supply line 15. Overflow outlet 17 extends out of side wall 8 (see FIG. 2 also) of barrel 9 for a distance 13 that is sufficient to detachably connect an overflow discharge line 18 that diverts rainwater and debris out of barrel 9 and away from any nearby buildings or foundations to prevent problems that are commonly associated with the build-up of water near such foundations, such as a cracking, leaking or shifting foundation. Preferably, overflow discharge line 18 is sized such that it friction fits over overflow outlet 17. Alternatively, overflow discharge line 18 can be permanently attached to overflow outlet 17 using sheet metal screws. It is preferred that all interfacing components (such as barrel 9 and drainage outlet 26) that have the potential to leak water from the system be fabricated of plastic, rather than mixing some metal components with some plastic components, to prevent leaks caused by components expanding at different rates due to being comprised of different materials.

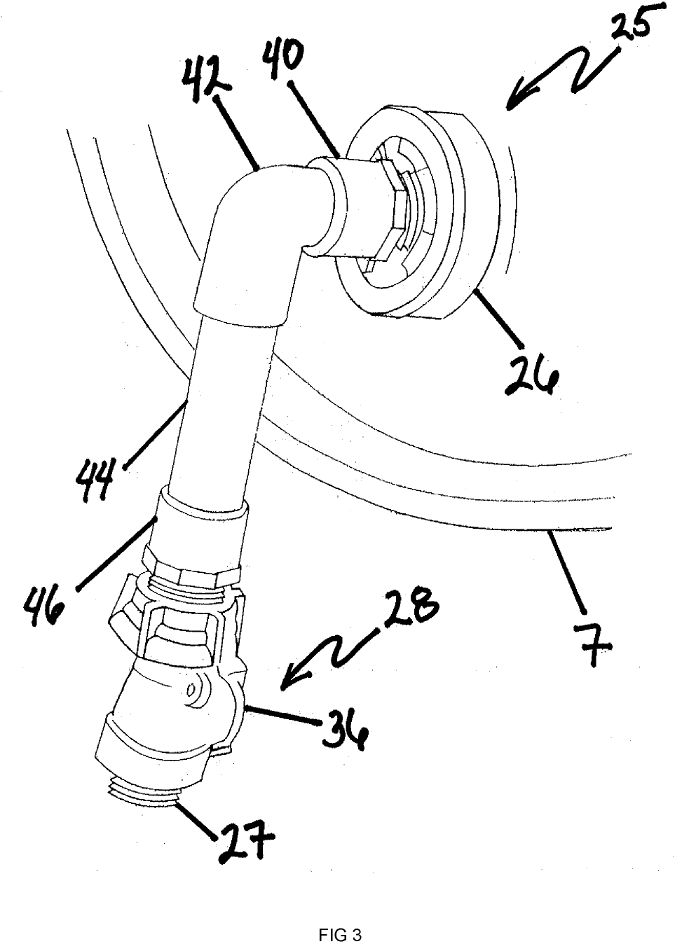

With reference to FIG. 3, hose assembly 25 is preferably comprised of a drain coupling 40 that is attached to drainage outlet 26, an elbow fitting 42 that is fixedly attached to drain coupling 40, a length of tubing 44 that is fixedly attached to elbow 42 at one end and a spigot coupling 46 at the other end, and a spigot 28 that is fixedly attached to spigot coupling 46. Spigot 28 is comprised of a spigot handle 32 (visible in FIG. 1), a spigot valve 36, and a threaded end 27. In addition to this preferred embodiment, there are a number of ways to create a sufficient hose assembly, but preferably assembly 25 extends from bottom wall 7 of barrel 9 rather than side wall 8 to provide for optimal water pressure and sediment removal through assembly 25, and assembly 25 preferably begins with elbow 42 and connects to spigot 28 through a length of tubing 44 without any further elbows or bends.

In use, rainwater is captured and directed through supply line 15 into barrel 9. Supply line 15 can be a conventional gutter downspout that is routed from the portion of a gutter (not depicted) located at the line of the rooftop (not depicted) to barrel inlet 16. To dispense rainwater for domestic uses, a conventional garden hose 50 may be screwed onto threaded end 27 of hose assembly 25. When spigot handle 32 of hose assembly 25 is in the open position, rainwater flows through garden hose 50 and can be used for a variety of domestic uses, such as irrigating foliage, filling outdoor bird baths or fountains, or washing a car or windows. When spigot handle 32 is in the closed position, rainwater is retained in barrel 9. When the level of rainwater in barrel 9 reaches or exceeds the level at which overflow outlet 17 is located, rainwater and any floating debris (not depicted) flows out of barrel 9 through overflow outlet 17 and is directed away from any buildings through overflow discharge line 18. Overflow discharge line 18 is preferably made of readily available rigid 4″ landscape pipe or a large flexible accordion-style hose that allows the user to define and redefine the direction of the overflow water such that it can also be used for a variety of domestic purposes similar to those described above for rainwater dispensed through spigot 28, as well as be able to direct the overflow water away from nearby buildings or foundations.

In the preferred embodiment, the rainwater capture and dispensation system 10 recycles a high-quality barrel 9 previously used in industry to hold substances such as such as orange juice concentrate or syrup and that, once emptied of its contents and cleaned, might otherwise be considered trash. The preferred barrel 9 is one having at least one threaded bung plug in bottom wall 7. A bung plug is an apparatus used to seal a container, such as a barrel. Whereas a lid seals a container from the outside, a bung plug seals a container by being inserted into an aperture within the container and displacing the inner volume of the container. The preferred embodiment of the present invention utilizes a barrel 9 that has been flipped upside down such that the bung plug is located in bottom wall 7 (as depicted in FIG. 2). Drainage outlet 26 is preferably sized such that, after removing the bung plug, drainage outlet 26 will simply thread into the existing aperture originally designed to receive the bung plug, thereby rendering construction of the present invention a more efficient process and avoiding the unnecessary task of drilling an aperture in barrel 9 to allow rainwater to be dispensed. This preferred method of installing drainage outlet 26 also prevents leaks from inadequate seals that may result from a drainage outlet otherwise constructed by drilling an aperture and then installing an apparatus to dispense rainwater because the use of an existing bung plug better maintains the integrity of barrel 9. Also, in the preferred embodiment base 2 is comprised of one or more conventional cinder blocks. Barrel 9 can be raised higher to create greater water pressure at spigot 28 by constructing any manner of platform-type structure.

In an alternative embodiment (not depicted, but structural components are similar to those previously described), two or more rainwater capture and dispensation systems 10 are daisy-chained together such that overflow discharge line 18 of the first barrel 9 is the supply line for the second barrel, and so on for each barrel thereafter. Each barrel must be lower than the previous barrel in the series such that the subsequent barrel's inlet 16 is lower than the previous barrel's overflow outlet 17. A continuation of this alternative arrangement may include utilizing multiple series of barrels in parallel, with at least one barrel having multiple overflow outlets 17 to allow for the creation of multiple series of barrels emanating from a single barrel. In another alternative embodiment, a subsequent barrel is fitted with two overflow outlets, and the first barrel's overflow drainage line 18 is connected to the second overflow outlet 17 of a second or subsequent barrel. Again, the subsequent barrel's second overflow outlet 17 is lower than the previous barrel's overflow outlet 18. Additionally, the subsequent barrel is fitted with two hose assemblies 25 such that the previous barrel's hose assembly can be connected to the subsequent barrel's second hose assembly via an appropriately sized piece of tubing or garden hose. In this latter alternative embodiment, it is preferable that a subsequent barrel 9 is made from a recycled high-quality barrel having two threaded bung plugs in bottom wall 6 to accommodate both hose assemblies.

An alternative use for the present invention is to aid in controlling storm surge. More specifically, storm surge refers to when a large volume of rain falls and, for example, enters a sewer system and overwhelms the sewer system infrastructure or saturates the ground and causes flooding. In some areas of the country, storm drains empty into a sewer system. When this occurs, the volume of fluid entering the drains cause the sewer system infrastructure to be overwhelmed, which can cause raw sewage to be discharged into local waterways. To address these potentially hazardous situations, the present invention can be used to capture and withhold water from the storm surge and then release it at a later time when the ground is capable of absorbing it or a sewer system will not be overwhelmed, based on monitoring of the ground saturation level or sewer system capacity and volume, respectively.

Whereas the figures and description have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of patent monopoly to be granted.

What is claimed is:

1. A method of collecting captured rainwater in a storage barrel having a sidewall and a bottom wall, an overflow port located in said sidewall and a drainage outlet located in said bottom wall, said method comprising the steps of:
(a) holding said captured rainwater;
(b) expelling excess captured rainwater through said overflow outlet under the influence of the pressure of said captured rainwater within said storage barrel;
(c) removing debris floating on or suspended in said captured rainwater through said step of expelling;
(d) dispensing captured rainwater through said drainage outlet;
(e) collecting sediment on said bottom wall; and
(f) purging said sediment as part of said step of dispensing.

2. The method of collecting rainwater of claim 1 further comprising the step of reusing a pre-existing barrel as said storage barrel, said pre-existing barrel including a bung plug.

3. The method of collecting rainwater of claim 2 further comprising the step of adapting said bung plug to function as said drainage outlet.

4. The method of collecting rainwater of claim 1 further comprising the steps of capturing the rainwater generated by a storm, monitoring the water saturation of the ground, and dispensing said captured rainwater generated by said storm at a time when said monitoring indicates that said ground is capable of absorbing more water without becoming saturated.

5. The method of collecting rainwater of claim 1 further comprising the steps of capturing the rainwater generated by a storm before it enters a sewer system, monitoring the capacity and volume of the sewer system, and dispensing said captured rainwater generated by said storm at a time when said monitoring indicates that releasing said captured rainwater will not cause said volume to exceed said capacity of said sewer system.

6. The method of collecting rainwater of claim 1 wherein said step of expelling occurs at a rate equal to or greater than the rate of capturing rainwater in said storage barrel.

7. A method of collecting rainwater through the use of two or more barrels including sidewalls and bottom walls, each of said two or more barrels including at least one overflow port located in said sidewalls such that a first barrel includes a first overflow port and a second barrel includes a second overflow port, and each of said two or more barrels includes at least one drainage outlet located in said bottom walls, said method comprising the steps of:
(a) capturing said rainwater in said first barrel;
(b) connecting said first overflow port to said second overflow port;
(c) allowing rainwater to flow from said first overflow port to said second overflow port;
(d) removing debris floating on or suspended in said rainwater through a third overflow port located in one of said two or more barrels; and
(e) dispensing captured rainwater through at least one of said drainage outlets.

8. The method of collecting rainwater of claim 7 further comprising the step of linking two or more of said at least one drainage outlets.

9. The method of collecting rainwater of claim 7 further comprising the step of connecting said two or more barrels in series.

10. The method of collecting rainwater of claim 7 further comprising the step of connecting said two or more barrels in parallel.

11. The method of collecting rainwater of claim 7 further comprising the step of connecting said two or more barrels such that some of said two or more barrels are in series and others of said two or more barrels are in parallel.
